(19) United States
(12) Patent Application Publication
(10) Pub. No.: US 2025/0025794 A1
(43) Pub. Date: Jan. 23, 2025

(54) APPARATUS AND METHOD FOR MANAGING GAME ASSET

(71) Applicant: DEVCAT CO., LTD., Seoul (KR)

(72) Inventor: Dong-Gun KIM, Seoul (KR)

(21) Appl. No.: 18/910,528

(22) Filed: Oct. 9, 2024

Related U.S. Application Data
(63) Continuation of application No. PCT/KR2023/004160, filed on Mar. 29, 2023.

(30) Foreign Application Priority Data
Apr. 20, 2022 (KR) 10-2022-0049138

(51) Int. Cl. A63F 13/85; A63F 13/30

(52) U.S. Cl. CPC A63F 13/85; A63F 13/30

(57) ABSTRACT

The embodiments disclosed herein are directed to an apparatus and method for managing game asset. According to an embodiment, there is provided an apparatus for managing game asset, the apparatus including: a communication interface configured to communicate with a game server, and a controller configured to generate an asset code corresponding to a game asset in the game server and register the asset code on a blockchain network.

### CROSS-REFERENCE TO RELATED APPLICATION

The present application is a continuation of PCT/KR2023/004160, filed on Mar. 29, 2023, which claims priority to Korean Patent Application No. 10-2022-0049138, filed on Apr. 20, 2022, the entire contents of which are incorporated herein for all purposes by this reference.

### TECHNICAL FIELD

The embodiments disclosed herein relate to an apparatus for managing game asset and a method of managing game asset, and more specifically to an apparatus and method that manage game assets by using a blockchain network.

### BACKGROUND ART

Recently, due to the development of the Internet, various types of online games have been developed and popularized. Usually, online games stimulate users' interest in the games by allowing users to own game assets such as characters, pets, or items.

Game assets such as characters, items, etc. are subject to trading and are often traded at high prices, so that they are also subject to management. In order to check, manage, or trade these game assets, users need to access online game servers and check the game assets.

However, game servers sometimes stop operating due to system maintenance or other reasons or game servers are hacked, so that users experience inconvenience in managing or trading their game assets. This reduces users' interest in games and causes them to leave the games. Furthermore, there is a problem in that purchasers who want to purchase game assets have difficulty checking the status of the game assets they want to purchase and, when sellers deceive them about the status of the game assets, they have no choice but to be deceived.

Accordingly, methods for game users to separate game assets from game servers and preserve them start to be pursued. Furthermore, there is a need for the development of technology that allows game assets to be entirely sold, partially sold, or rented to others more easily. Moreover, there is a need for the development of technology that allows users who wish to trade game assets to check the status of the game assets and trade them more securely.

In connection with this, according to Korean Patent No. 10-1827323 entitled ‘Game Asset Processing System Associated with Web Activities,’ the above-described related art proposes a technology that allows users using online game services to obtain game assets through activities on a website.

However, conventional technologies, including the above-described related art, only propose technologies for increasing game assets, and do not overcome the above-described problem. Therefore, there is a need for a new level of function that overcomes the above-described problem and further improves the satisfaction of game users.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### DISCLOSURE

### Technical Problem

An object of the embodiments disclosed herein is to propose an apparatus and method for managing game asset.

An object of the embodiments disclosed herein is to propose an apparatus and method for managing game asset that enable a user to separate game assets from a game server and preserve them.

An object of the embodiments disclosed herein is to propose an apparatus and method for managing game asset that allow a user to securely preserve and view his or her game assets regardless of the operation or status of a game server.

An object of the embodiments disclosed herein is to propose an apparatus and method for managing game asset that allow a user to more easily entirely sell, partially sell, or rent his or her game assets to another person.

An object of the embodiments disclosed herein is to propose an apparatus and method for managing game asset that allow a user to easily check the status of his or her game assets.

### Technical Solution

As a technical solution for achieving the above-described object, according to an embodiment, there is provided an apparatus for managing game asset, the apparatus including: a communication interface configured to communicate with a game server; and a controller configured to generate an asset code corresponding to a game asset in the game server and register the asset code on a blockchain network.

According to another embodiment, there is provided a method of managing game asset, the method including: generating an asset code corresponding to a game asset in a game server, and registering the asset code on a blockchain network.

According to still another embodiment, there is provided a computer-readable storage medium including instructions for causing a computer to perform a method of managing game asset. The method of managing game asset includes generating an asset code corresponding to a game asset in a game server, and registering the asset code on a blockchain network.

According to still another embodiment, there is provided a program that is performed by an apparatus for managing game asset and includes instructions for causing the apparatus for managing game asset to perform a method of managing game asset. The method of managing game asset includes generating an asset code corresponding to a game asset in a game server, and registering the asset code on a blockchain network.

### Advantageous Effects

According to any one of the above-described technical solutions, there are proposed the apparatus and method for managing game asset.

According to any one of the above-described technical solutions, there are proposed the apparatus and method for managing game asset that enable a game user to separate game assets from the game server and preserve them.

According to any one of the above-described technical solutions, there are proposed the apparatus and method for managing game asset that allow a game user to securely preserve and view his or her game assets regardless of the operation or status of the game server. Through this, the game user may freely trade, rent, and partially own assets in a place separate from a game world, which can further increase the user's utilization and degree of freedom of the user's virtual assets.

According to any one of the above-described technical solutions, there are proposed the apparatus and method for managing game asset that allow a user to more easily entirely sell, partially sell, or rent his or her game assets to another person.

According to any one of the above-described technical solutions, there are proposed the apparatus and method for managing game asset that allow a user to easily check the status of his or her game assets. Accordingly, a purchaser or seller who wants to purchase or sell game assets may check the status of the game assets and then proceed with trading, which can protect participants in the trading of game assets.

The effects that can be obtained by the embodiments disclosed herein are not limited to the above-described effects, and other effects that have not been described above will be clearly understood by those having ordinary skill in the art, to which the disclosed embodiments pertain, from the following description.

### DESCRIPTION OF DRAWINGS

FIG. 1 is a system diagram illustrating an apparatus for managing game asset according to an embodiment;

FIG. 2 is a block diagram showing an apparatus for managing game asset according to an embodiment;

FIGS. 3 to 7 are exemplary diagrams illustrating an apparatus for managing game asset according to an embodiment; and

FIGS. 8 and 9 are flowcharts illustrating a method of managing game asset according to an embodiment.

### MODE FOR INVENTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

Embodiments will be described in detail below with reference to the accompanying drawings.

Meanwhile, prior to the following description, the meanings of the terms to be used below will be defined first.

First, the “blockchain” may refer to a distributed Peer-to-Peer (P2P) system for a ledger that utilizes software elements composed of algorithms by which blocks, which are sequentially connected to secure and maintain integrity, negotiate transaction information by using encryption and security technologies. In this case, the distributed P2P system may be a special type of distributed system. Furthermore, the P2P system enables all the nodes of a network to provide resources (processing power, storage space, data or network bandwidth, and the like) to each other without the coordination of a central node. Moreover, the “blockchain” may refer to a distributed ledger technology that enables a ledger, in which transaction information is recorded, to be distributed across a P2P network rather than being stored in the central server of a specific institution and also enables nodes within the network to record and manage the ledger jointly. In this case, the “node” may refer to a component within a blockchain network. For example, the node may be, but is not limited to, a special-purpose computer, a general-purpose computer, a supercomputer, a mainframe computer, a personal computer (PC), a smartphone, a tablet PC, a PC, a television, a smart TV, a mobile phone, a personal digital assistant (PDA), or the like.

Furthermore, the “game asset” refers to a virtual asset that can belong to a game user who plays a game and can be the subject of trading. A game asset can be a character, an item, a pet, game money, goods, a point, or the like.

In addition to the terms defined above, terms that require descriptions will be described separately below.

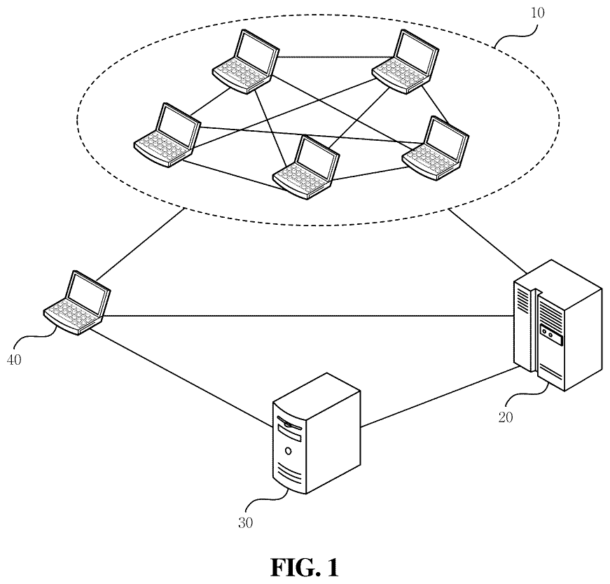

FIG. 1 is a system diagram illustrating an apparatus for managing game asset according to an embodiment, and shows a blockchain network 10, an apparatus 20 for managing game asset, a game server 30, and a user terminal 40 according to an embodiment.

The blockchain network 10, the apparatus 20 for managing game asset, the game server 30, and the user terminal 40 may communicate with each other over a network. Furthermore, each of the apparatus 20 for managing game asset, the game server 30, and the user terminal 40 may correspond to a component within the blockchain network 10.

The blockchain network 10 includes a plurality of nodes, and the nodes may be connected to each other and manage data in a distributed manner. For example, the blockchain network 10 may store data, the content of smart contracts, transactions, and the like used to provide service in the apparatus 20 for managing game asset. Each of the apparatus 20 for managing game asset, the game server 30, and the user terminal 40 may request and obtain various types of data stored in the blockchain network 10.

Smart contracts, transactions, and the like uploaded to the blockchain network 10 may not be easily forged because the plurality of nodes are connected and store data. The blockchain network 10 may be implemented as a private blockchain or a public blockchain.

According to an embodiment, the blockchain network 10 may register an asset code corresponding to each game asset and record each transaction of the asset code.

Meanwhile, the game server 30 stores various types of information required for providing a game, and detects and records various events occurring in the game, thereby enabling the game to progress in a chronological sequence. The game server 30 may provide game service to the user terminal 40 over the network. The game server 30 may be implemented as a computer capable of communicating over a network or as a cloud computing server.

According to an embodiment, the game server 30 may delete or register information about a user's game asset in the user's account in response to a request from the apparatus 20 for managing game asset. For example, the game server 30 may delete an item, which is the user's game asset, from the user's account in response to a request from the apparatus 20 for managing game asset, and accordingly, the user may no longer check the item because the item is deleted from his or her own items. Furthermore, for example, the game server 30 may store an item, which is the user's game asset, in the user's account in response to a request from the apparatus 20 for managing game asset, and the user may check the stored item as his or her own items.

Meanwhile, the user terminal 40 may be implemented as an electronic terminal in which an application capable of interacting with a user who wants to play a game or trade a game asset (or an asset code) is installed. In this case, the electronic terminal may be implemented as a computer, a mobile terminal, a television, a wearable device, or the like that can access a remote server over a network or connect with another terminal and a server. In this case, the computer includes, e.g., a notebook, a desktop, a laptop, and the like each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like. Furthermore, the television may include an Internet Protocol Television (IPTV), an Internet Television (Internet TV), a terrestrial TV, a cable TV, and the like. Moreover, the wearable device is an information processing device of a type that can be directly worn on a human body, such as a watch, glasses, an accessory, clothing, shoes, or the like, and can access a remote server or be connected to another terminal directly or via another information processing device over a network.

The user may request the separation or restoration of a game asset stored in the user account in the game server 30 through the user terminal 40, or may request the viewing of the transaction of an asset code corresponding to a game asset.

Meanwhile, the apparatus 20 for managing game asset is an apparatus that manages the user's game assets according to a method of managing game asset.

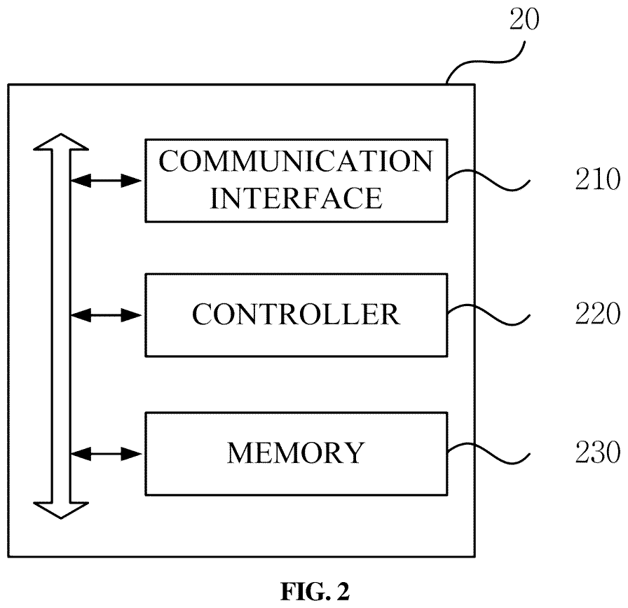

In connection with this, FIG. 2 is a block diagram showing an apparatus for managing game asset according to an embodiment.

As shown in FIG. 2, the apparatus 20 for managing game asset according to an embodiment may include a communication interface 210, a controller 220, and memory 230.

The communication interface 210 may perform wired/wireless communication with another terminal or a network. For example, the communication interface 110 may transmit/receive various types of information required to perform a method of managing game asset by communicating with a third server. To this end, the communication interface 210 may include a communication module that supports at least one of various wired/wireless communication methods. For example, the communication module may be implemented in the form of a chipset.

In this case, the wireless communication supported by the communication interface 210 may be, e.g., Wireless Fidelity (Wi-Fi), Wi-Fi Direct, Bluetooth, Ultra-Wide Band (UWB), Near Field Communication (NFC), or the like. Furthermore, the wired communication supported by the communication interface 210 may be, e.g., Universal Serial Bus (USB), High Definition Multimedia Interface (HDMI), or the like.

According to an embodiment, the communication interface 210 may transmit and receive information about a game asset or information for requesting the deletion or storage of a game asset while communicating with the game server 30. Furthermore, the communication interface 210 may obtain a separation request, a restoration request, or intermediary information from the user terminal 40 used by the game user, and may transmit the results of an operation based on the information to the user terminal 40.

Meanwhile, the controller 220 may control the overall operation of the apparatus 20 for managing game asset, and may include a processor such as a CPU, a GPU, or the like. The controller 220 may control other components included in the apparatus 20 for managing game asset to perform operations corresponding to input from the game user. For example, the controller 220 may execute a program stored in the memory 230 to be described later, may read a file stored in the memory 230, or may store a new file in the memory 230.

According to an embodiment, the controller 220 may generate an asset code corresponding to a game asset.

That is, when the controller 220 receives a request for the separation of a game asset in the game server 30 from a user, it may generate an asset code for the game asset whose separation has been requested. For example, a user who plays a game may wish to separate an item that he or she owns from the game server 30 and preserve it. Accordingly, the user may select the corresponding item and request separation through the user terminal 40. In response to this separation request, the controller 220 may generate an asset code for the selected item.

According to an embodiment, the controller 220 may issue a universally unique identifier (UUID) or an index for a game asset, and may make the UUID or index correspond to the game asset in a one-to-one correspondence as an asset code. Through this, the controller 220 may guarantee the uniqueness of the asset code.

According to one embodiment, when generating an asset code, the controller 220 may also match a password to the asset code and then store them. Accordingly, in the case where an attempt is made to restore an asset code to a game asset, the controller 220 may restore the asset code to the game asset only when information matching the password is obtained. This prevents the game asset from being stolen.

Furthermore, according to another embodiment, when generating an asset code, the controller 220 may delete information about a corresponding game asset from the game server 30 where a user account, in which the game asset is stored, is present. In other words, the game server 30 may be requested to delete the game asset from the user account. In another example, the controller 220 may also delete the game asset stored in the user account by deactivating it. In this manner, the game asset converted into the asset code is processed as if it disappeared from the user account, thereby making the user feel that his or her own game asset has been separated from the game server 30 and moved.

Meanwhile, the controller 220 may register the asset code on the blockchain network 10. The unauthorized modification or deletion of the asset code is prevented by registering the asset code on the blockchain network 10.

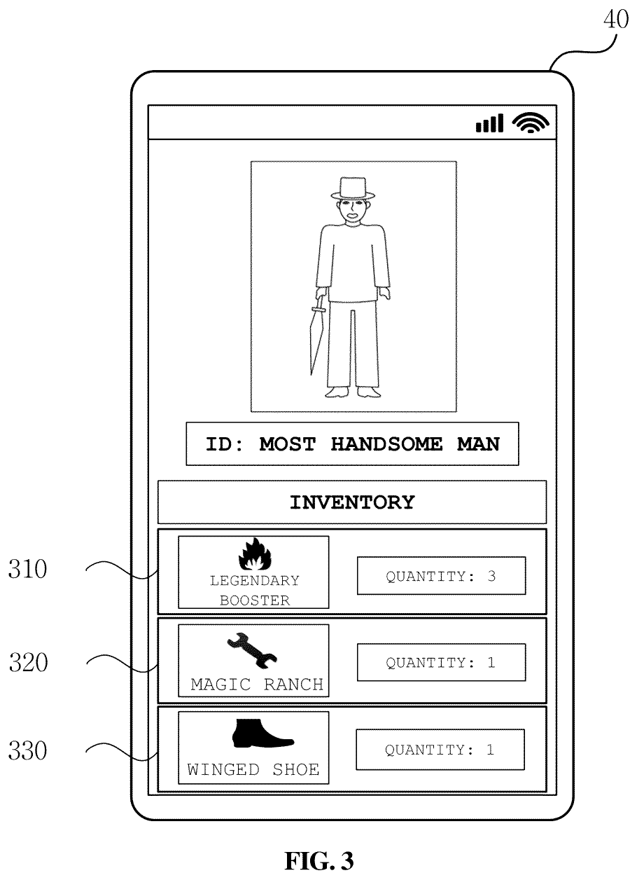

In connection with this, FIGS. 3 to 5 are exemplary diagrams illustrating an apparatus for managing game asset according to an embodiment disclosed herein, and show what is displayed through the screen of the user terminal 40.

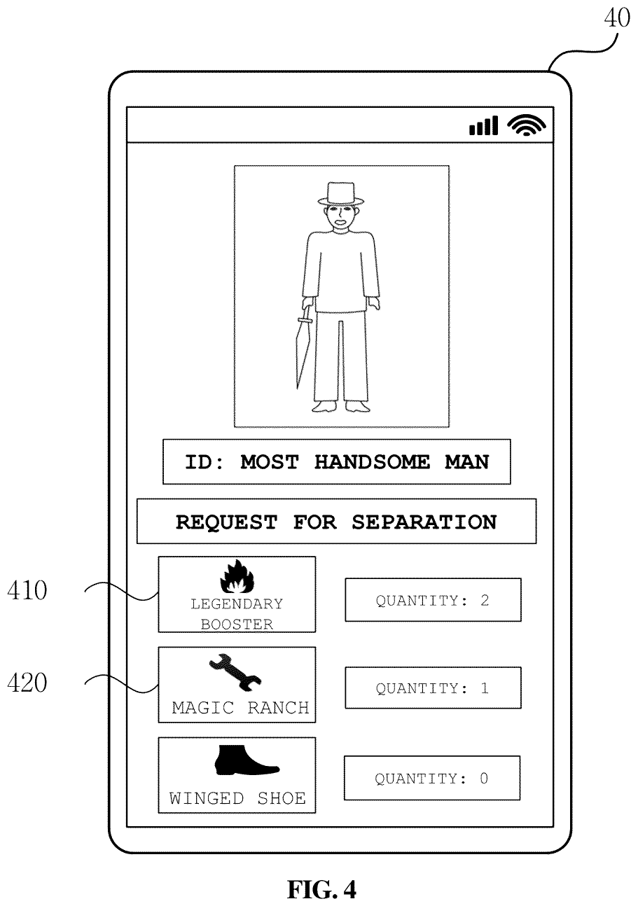

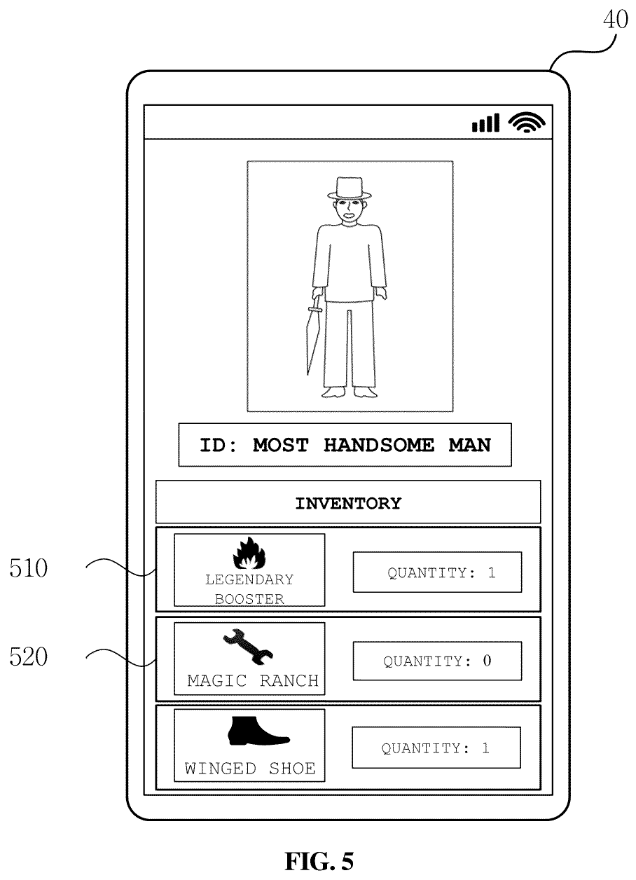

As shown in FIG. 3, the inventory of the user ‘Best Handsome Man’ may include three ‘Legendary Boosters 310,’ one ‘Magic Wrench 320,’ and one ‘Winged Shoe 330.’ As shown in FIG. 4, the user may request the separation of two ‘Legendary Boosters 410’ and may also request the separation of one ‘Magic Wrench 420.’ When the controller 220 processes the separation of the user's game assets according to the above-described embodiment, the user's game assets may be processed as if they were separated from the game server 30, as shown in FIG. 5. That is, as shown in FIG. 5, one of the three ‘Legendary Booster 510’ that originally were present is now in the inventory as two of them were requested to be separated, and one ‘Magic Wrench 520’ that originally was present is no longer in the inventory as one ‘Magic Wrench 520’ was requested to be separated. Through this, the user may feel that his or her game assets have been separated from the game server and moved to a device that manages game assets.

Meanwhile, game assets may be ‘traded.’ Trade may be one of full sale, partial sale, and rental. Accordingly, when a game asset is traded, the ownership of the game asset may be sold as a whole or may be divided into shares, or the game asset may be rented. For example, a character may be sold and, thus, the owner thereof may be changed from one user to another or a plurality of users may own the character by share. Alternatively, for example, a character may be rented to another user for a predetermined period of time and then returned to an owner. As game assets may be traded in this way, asset codes corresponding to the game assets may be traded. Accordingly, the status information of a game asset may include information about at least one of the information on the sale, the shared ownership, and rental of the game asset, and may also include information about the trading history. For example, the status information of a game asset may include owner identification information, information about each owner's identification information and each owner's share in the case of shared ownership status, information about the most recent owner, and/or information about a renter, a rental date, and a return date. The status information of an asset code refers to the status information of a game asset corresponding to the asset code. In the following, the status information of an asset code and the status information of a game asset are used interchangeably.

According to an embodiment, whenever a game asset is traded, the transaction of an asset code may be transmitted to the blockchain network 10. The transaction of the asset code may be information generated as a result of the trading of the asset code, and the transaction information may be information about the results of the trading. Accordingly, for example, when a user's asset code is transferred to another user, the controller 220 may encrypt a transaction for a change in the ownership of the asset code and register it on the blockchain network 10. A node of the blockchain network 10 may generate a valid block by decrypting the encrypted transaction, verifying whether the transaction is valid based on the results of the decryption, and recording the transaction and also performing proof of work only when it is valid, and may also transmit the transaction to another node. Accordingly, the nodes of the blockchain network 10 may add a valid block regarding the transaction. In this manner, the valid transaction may be transmitted to the nodes on the blockchain network 10 and recorded in the blockchain. Stability may be strengthened by registering the transaction of the asset code on the blockchain network 10.

When the transaction of the asset code is registered on the blockchain network 10, the controller 220 according to an embodiment may scan blockchain data in real time and store it in the memory 230, and may provide the status information of the asset code in response to a request when a request is made to view the asset code in the future. According to another embodiment, at the time when a request is made to view the asset code, the controller 220 may scan blockchain data and provide the status information of the asset code. According to still another embodiment, the controller 220 may update the status information of the asset code and then store it in the memory 230 whenever the transaction of the asset code is recorded in the blockchain network 10, and may provide the status information of the asset code stored in the memory 230 when a request is made to view the asset code in the future.

Meanwhile, according to an embodiment, the controller 220 may provide intermediary information for the provision of the status information of the asset code. That is, the controller 220 may provide intermediary information for the viewing of the transaction of the asset code.

To this end, the controller 220 may generate intermediary information. In this case, the ‘intermediary information’ may be, but is not limited to, a string, a one-dimensional code (e.g., a barcode), or a two-dimensional code (e.g., a QR code). For example, the string may be the asset code itself, may include arbitrary characters generated in accordance with the asset code, or may be implemented as a hyperlink that enables movement to a webpage containing the status information of the asset code. Alternatively, for example, the data area of the QR code may contain the asset code itself, may contain the status information of the asset code represented by a text, an image, or a video, or may contain information that enables movement directly to a webpage on which the status information of the asset code is posted. The controller 220 may generate and provide the intermediary information according to a request from a user who wishes to view the status of the asset code, may generate and provide the intermediary information periodically, may generate and provide the intermediary information when generating the asset code, or may generate and provide the intermediary information when the trading of the asset code occurs.

When the controller 220 obtains the intermediary information through the user terminal 40, the controller 220 may determine that there is a request to view the asset code corresponding to the intermediary information, and may provide status information about the asset code corresponding to the intermediary information. For example, when the asset code to be viewed is specified based on the intermediary information, the controller 220 may provide a text, an image, a video, or a webpage including the status information of the asset code previously stored in the memory 230, or may search for a valid block related to the transaction of the corresponding asset code in the blockchain network 10 and provide a text, an image, a video, or a webpage including status information on the corresponding asset code. Furthermore, for example, the controller 220 may extract and provide a text, an image, a video, or the like related to the status information of the asset code from the intermediary information, or may provide the status information of the asset code recorded on the webpage by providing a webpage extracted from the intermediary information.

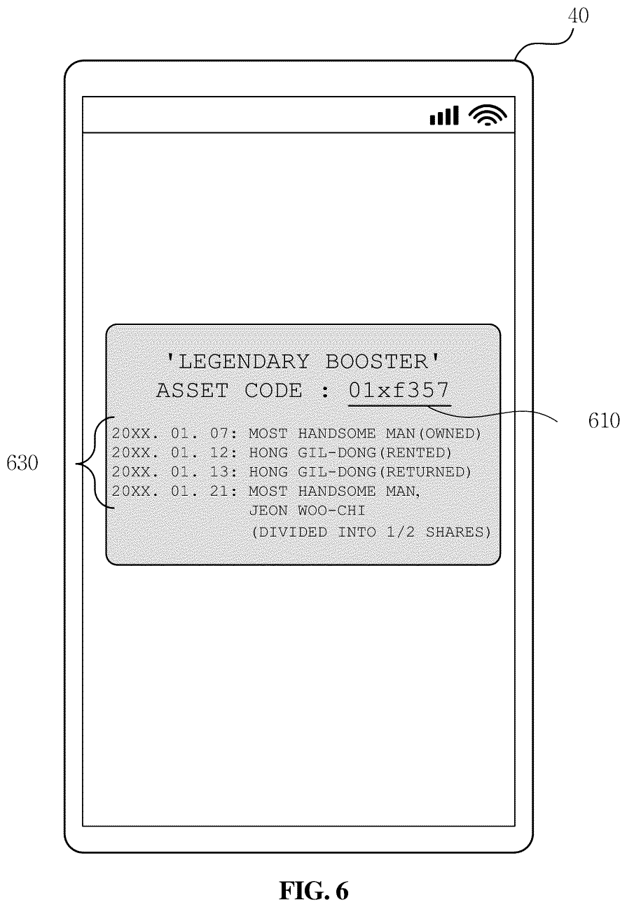

In connection with this, FIG. 6 is an exemplary diagram illustrating an apparatus for managing game asset according to an embodiment disclosed herein, and shows what is displayed through the screen of a user terminal 40.

The user may read a QR code or barcode, input a string, or click a hyperlink through the user terminal 40. Accordingly, the user may be provided with the status information of the asset code corresponding to the QR code, barcode, or string, or may be provided with the status information of the asset code included in a webpage connected through the hyperlink.

That is, as shown in FIG. 6, the controller 220 may provide the status information 630 of an asset code 610 requested by the user. Accordingly, the user may become aware that the game asset ‘Legendary Booster’ was solely owned by ‘Most Handsome Man’ on January 7 and then was divided into ½ shares by ‘Most Handsome Man’ and ‘Jeon Woo-chi’ on January 21, and may also become aware that ‘Hong Gil-dong’ rented the game asset from January 12 to January 13 and then returned it.

In this manner, through the intermediary information, the user may check status information regarding the history of changes in the ownership of a game asset, the status of shared ownership, rental, etc.

Meanwhile, according to an embodiment, the controller 220 may restore an asset code.

When a request for the restoration of an asset code is received from the user through the user terminal 40, when a predetermined amount of time has elapsed since conversion into the asset code, or when the elapsed time from conversion into the asset code is equal to or exceeds a time preset by the user, the controller 220 may process the restoration of the asset code. For example, the controller 220 may restore a game asset corresponding to an asset code by storing it in the game server 30, or may restore a game asset by activating the game asset that has already been stored but deactivated in a user account. In this case, the controller 220 may store the game asset in the owner account in the game server 30 so that the game asset is attributed to the owner of the game asset at the time when restoration is performed based on the status information of the asset code.

According to an embodiment, the controller 220 may obtain the asset code to be restored by also obtaining intermediary information when obtaining a restoration request. For example, the user may specify the asset code to be restored by entering a string representing the asset code or taking a picture of a barcode or QR code.

In this case, the controller 220 may also obtain the identification information of the user requesting restoration, may determine whether the user identification information and the owner at the time when restoration is performed included in the status information of the asset code match each other, and may process the restoration when they match each other and may not perform the restoration when they do not match each other.

Furthermore, the controller 220 may obtain the identification information of the user requesting restoration, and may determine whether the user identification information and the owner at the time when the restoration is performed included in the transaction information match each other. The controller 220 may not process the restoration when the game asset is under shared ownership. Alternatively, the controller 220 may determine whether the user requesting restoration has obtained consent from the other owner of shared ownership, and may process the restoration only when consent has been obtained. The controller 220 may process the restoration so that the game asset is stored in the account of the user requesting restoration, but may pay at least a portion of a price (e.g., cash, game money, points, or the like) equivalent to the game asset to the other owner of the shared ownership.

Furthermore, the controller 220 may also obtain a password from the user requesting restoration, and may process the restoration only when the obtained password matches the password generated at the time when the asset code was generated. Through this, the game asset is attributed to the owner who has the right to the game asset.

The controller 220 may delete an asset code corresponding to the game asset from the memory 230 when the game asset is restored in the game server 30. Furthermore, the controller 220 may update the blockchain network 10 with the fact that the corresponding asset code has been deleted when the game asset is restored in the game server 30, or may request that data related to the asset code be deleted. The game server 30 may determine that the game asset has been restored as the game asset is stored in a user account, and may perform processing so that the user of the corresponding user account plays a game using the corresponding game asset. Accordingly, for example, when the game asset is a character, the game server 30 may allow the user to control the corresponding character and play the game. In contrast, when the game asset is an item, the game server 30 may allow effects attributable to the use of the item to be generated by using the corresponding item during the playing of the game.

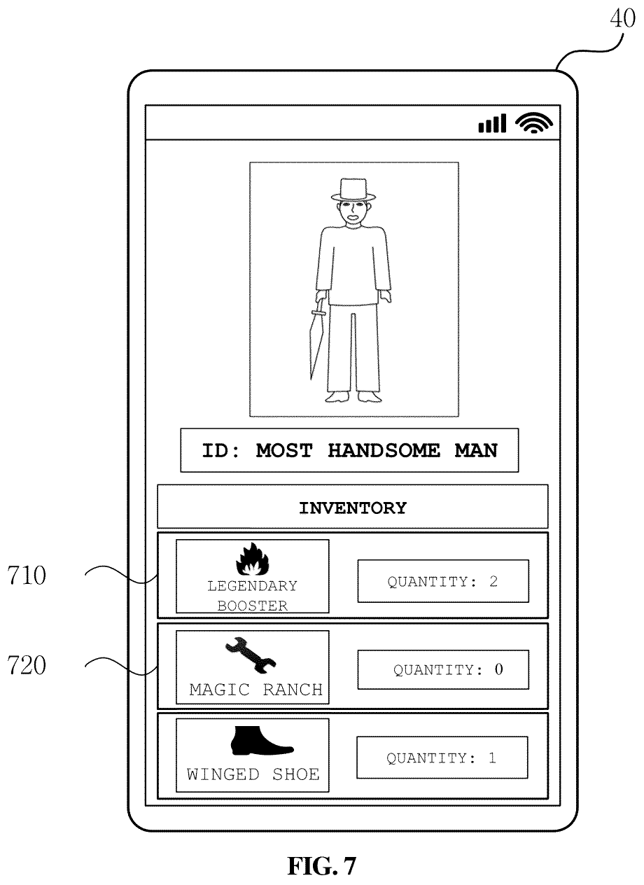

In connection with this, FIG. 7 is an exemplary diagram illustrating an apparatus for managing game asset according to an embodiment disclosed herein, and illustrates what is displayed on the screen of the user terminal 40.

For example, when the controller 220 processes the restoration request of an owner for one ‘Legendary Booster,’ the user who had the inventory shown in FIG. 5 will have the inventory shown in FIG. 7. That is, it may be determined that the number of ‘Legendary Boosters’ for which restoration was requested has increased from 1 to 2, while the number of Magic Wrenches' for which restoration was not requested is still 0.

Meanwhile, according to an embodiment, the controller 220 may measure a management period from the time when a game asset was converted into an asset code to the time when it is restored, and may then provide rewards. That is, the controller 220 may restore an asset code, and may provide rewards based on the management period, which is the period from the time when a game asset was converted into the asset code to the time when it is restored. In this case, the time when a game asset was converted into the asset code may be the time when the separation of the game asset was requested or the time when the asset code corresponding to the game asset was generated. Furthermore, the time when it is restored may be the time when the restoration is requested or the time when the restoration is completed. This allows the user to experience the game server's resource savings and minimized load. It also enables the adjustment of the amount of game assets separated from the server, thereby maintaining the balance of game assets on the server. For example, the controller 220 may provide differentiated rewards according to the management period. For example, the controller 220 may provide goods such as cash, or may provide a game asset available in the game server 30.

According to an embodiment, the controller 220 may provide more rewards as the management period becomes longer, thereby promoting the separation of game assets and enabling the asset codes of game assets to be traded continuously to activate trading. According to another embodiment, the controller 220 may provide more rewards as the management period becomes shorter. For example, rewards for 0 to 5 days may be more than rewards for 5 to 10 days. Through this, it may be possible to prevent users from neglecting separated game assets. According to another embodiment, the controller 220 may set different rewards for each management period. In this case, the controller 220 may provide the most rewards for a given period, and may provide reduced rewards when the management period is shorter or longer than the corresponding period. In other words, the quantity of rewards for 11 to 20 days is set to be the largest quantity of rewards. The rewards for the management period of 0 to 10 days or 20 to 30 days may be set to a smaller quantity of rewards than the rewards for 11 to 20 days.

The controller 220 that wishes to provide rewards may provide rewards when a request for the restoration of the asset code is received, when the restoration of the asset code is completed, or when a predetermined period has elapsed after the completion of the restoration of the asset code.

Referring back to FIG. 2, various types of data such as files, applications, and programs may be installed and stored in the memory 230. The controller 220 may access and use data stored in the memory 230, or may store new data in the memory 230. Furthermore, the controller 220 may execute a program installed in the memory 230. For example, a program for performing a method of managing game asset may be installed in the memory 230.

According to an embodiment, the apparatus 20 for managing game asset may be implemented as a computer capable of communicating with the user terminal 40 over a network, or may be implemented as a cloud computing server. Furthermore, the apparatus 20 for managing game asset may be implemented as a component of the blockchain network 10. Since the apparatus 20 for managing game asset corresponds to a component of the blockchain network 10, the information stored in the memory 230 may be stored in the blockchain network 10. For example, information about game assets corresponding to asset codes may be stored in the memory 230 or stored in the blockchain network 10. Furthermore, the apparatus 20 for managing game asset may be implemented in a server or a blockchain network 10. For example, the communication interface 210 and the controller 220 may be implemented in the server, and the memory 230 may be implemented in the blockchain network 10.

The apparatus 20 for managing game asset according to the above-described embodiment may provide a custody service for a user's game assets. Furthermore, the apparatus 20 for managing game asset may provide a service that is differentiated from a non-fungible token (NFT) for preserving the uniqueness of a specific game item, and even the same game item may be converted into a different asset code and also restored, thereby encouraging the user's desire to increase game assets.

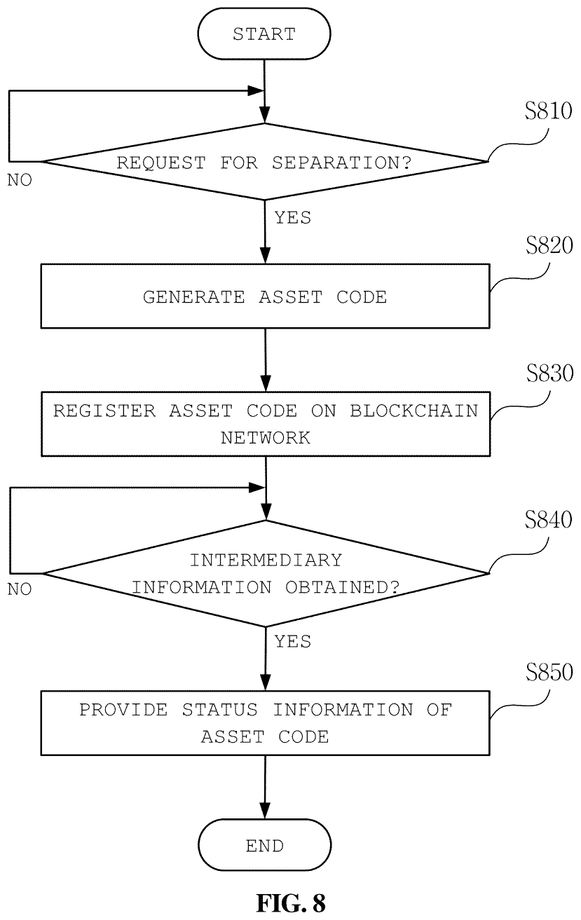

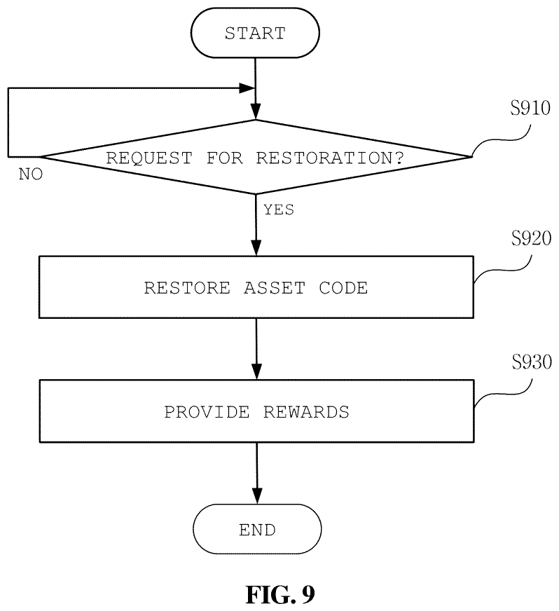

Meanwhile, FIGS. 8 and 9 are flowcharts illustrating a method of managing game asset according to an embodiment. The method of managing game asset according to the embodiment shown in FIGS. 8 and 9 includes steps that are processed in a time-series manner in the apparatus for managing game asset shown in FIGS. 1 to 7. Accordingly, the descriptions that are omitted below but have been given above in conjunction with the apparatus for managing game asset shown in FIGS. 1 to 7 may also be applied to the method of managing game asset according to the embodiment shown in FIGS. 8 and 9.

As shown in FIG. 8, when receiving a request for the separation of a game asset in the game server 30 in step S810, the apparatus 20 for managing game asset may generate an asset code corresponding to the game asset. In this case, the apparatus 20 for managing game asset may generate the asset code corresponding to the game asset in the game server 30, but may delete the game asset from a user account in the game server 30 where the game asset is stored.

Furthermore, the apparatus 20 for managing game asset may register the asset code in the blockchain network in step S830.

Thereafter, when the asset code is traded, the apparatus 20 for managing game asset may transmit the transaction of the asset code to the blockchain network 10. In order to view the transaction, the user may enter intermediary information through the user terminal 40.

In connection with this, the apparatus 20 for managing game asset may generate and provide intermediary information regarding the asset code, and may generate and provide intermediary information including at least one of the asset code and the status information of the corresponding asset code. Furthermore, the apparatus 20 for managing game asset may generate the intermediary information by generating at least one of a string, a one-dimensional code, and a two-dimensional code when generating the intermediary information regarding the asset code.

The apparatus 20 for managing game asset that has obtained the intermediary information in step S840 may provide the status information of the asset code in step S850. The status information includes at least one of pieces of information about the sale, rental, and shared ownership of the asset code, so that the user can check the current owner of the game asset, whether the game asset is under shared ownership, or whether the game asset is being rented by viewing the status information.

Meanwhile, as shown in FIG. 9, when receiving a request for the restoration of an asset code in step S910, the apparatus 20 for managing game asset may process the restoration of the asset code in step S920. In this case, the apparatus 20 for managing game asset may store a game asset corresponding to the asset code to be restored in a user account in the game server.

Furthermore, the apparatus 20 for managing game asset may provide rewards based on a management period from the time when the conversion of the game asset into the asset code was performed to the time when restoration is performed in step S930. According to an embodiment, step S930 may be terminated without being performed.

According to the method of managing game asset described above, a user may securely preserve and view his or her game assets regardless of the operation or status of the game server, and may freely trade, rent, and partially own the assets in a place separate from a game world, thereby allowing the user to freely utilize his or her virtual assets. Also, according to the method of managing game asset described above, game assets can be preserved and viewed separately from the game server, thereby saving game server resources and minimizing the load on the game server.

In this manner, the method of managing game asset according to the embodiment described through FIGS. 8 and 9 can be implemented as a computer program (or a computer program product) including instructions that cause a computer to perform the method of managing game asset.

Furthermore, the method of managing game asset according to the embodiment described through FIGS. 8 and 9 may be implemented as a computer-readable recording medium including instructions that cause the apparatus 20 for managing game asset to perform the method of managing game asset.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

The method of managing game asset according to the embodiments may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the method of managing game asset according to the embodiments may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the method of managing game asset according to the embodiments may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. An apparatus for managing game asset, the apparatus comprising:
a communication interface configured to communicate with a game server, and
a controller configured to generate an asset code corresponding to a game asset in the game server and register the asset code on a blockchain network.

2. The apparatus of claim 1, wherein the controller provides status information for the asset code when obtaining intermediary information for the asset code.

3. The apparatus of claim 1, wherein the controller transmits a transaction of the asset code to the blockchain network when trading of the asset code occurs.

4. The apparatus of claim 1, wherein the controller provides status information of the asset code, and particularly provides at least one of pieces of information about sale, rental, and shared ownership of the asset code.

5. The apparatus of claim 1, wherein the controller generates the asset code corresponding to the game asset in the game server, and deletes the game asset from a user account in the game server where the game asset is stored.

6. The apparatus of claim 1, wherein the controller restores the asset code, and stores the game asset corresponding to the asset code in a user account in the game server.

7. The apparatus of claim 6, wherein the controller restores the asset code, and provides rewards based on a management period from a time when the game asset was converted into the asset code to a time when the asset code is restored.

8. A method of managing game asset, the method comprising:
generating an asset code corresponding to a game asset in a game server, and
registering the asset code on a blockchain network.

9. The method of claim 8, further comprising providing status information for the asset code when obtaining intermediary information for the asset code.

10. The method of claim 8, further comprising transmitting a transaction of the asset code to the blockchain network when trading of the asset code occurs.

11. The method of claim 8, further comprising providing status information of the asset code, and particularly providing at least one of pieces of information about sale, rental, and shared ownership of the asset code.

12. The method of claim 8, wherein generating the asset code further comprises generating the asset code corresponding to the game asset in the game server and deleting the game asset from a user account in the game server where the game asset is stored.

13. The method of claim 8, further comprising restoring the asset code, and storing the game asset corresponding to the asset code in a user account in the game server.

14. A computer-readable storage medium including instructions for causing a computer to perform the method set forth in claim 8.

15. A program that is performed by an apparatus for managing game asset and includes instructions for causing the apparatus for managing game asset to perform the method set forth in claim 8.
